(19) United States
(12) Patent Application Publication
(10) Pub. No.: US 2008/0046412 A1
(43) Pub. Date: Feb. 21, 2008

(54) SYSTEM AND METHOD FOR MONITORING INFORMATION OF TRADEMARKS

(75) Inventors: CHUNG-I LEE, Tu-Cheng (TW); HAI-HONG LIN, Shenzhen (CN); DE-YI XIE, Shenzhen (CN); HAI-YUN CHEN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,944

(22) Filed: Dec. 23, 2006

(30) Foreign Application Priority Data
Aug. 18, 2006 (CN) 200610062177.X

(51) Int. Cl. G06F 17/30

(52) U.S. Cl. 707/3

(57) ABSTRACT

A method for monitoring information of trademarks via a trademark information Web site is disclosed. The trademark information Web site is accessible via the Internet. The method includes the steps of: setting search conditions, and periodically searching trademarks via the trademark information Web site according to the search conditions; obtaining a search result table in response to the searching, the search result table listing basic information of trademarks retrieved from the trademark information Web site under the search conditions; downloading detailed information of the trademarks in the search result table; and storing the detailed information of the trademarks downloaded into the database server. A related system is also disclosed.

### BACKGROUND OF THE INVENTION

1. Field of the Invention

The present invention generally relates to a system and method for monitoring information of intellectual properties, and more particularly, to a system and method for monitoring information of trademarks.

2. Description of Related Art

As competition grows, to remain competitive, enterprises pay more attention to their intellectual properties. Trademark, as important intellectual property, is acknowledged as a symbol of an enterprise, a product or a service.

Nowadays, numerous government patent offices have their trademark databases open to the public. Such offices include the United States Patent and Trademark Office (USPTO), the Trademark Office under the State Administration for Industry and Commerce of People's Republic of China (CTMO), and so on. The trademark databases are vast storehouses of integrated trademark information. By monitoring information of trademarks, we can conduct a series of activities regarding trademarks, such as getting the latest trademarks of competitors, guarding rights and interests of our trademarks, avoiding infringement, and analyzing trademark strategies of competitors.

Nevertheless, a major trademark database always contains an overwhelming number of trademarks, only a fraction of which are useful to a particular corporation. It is generally difficult, laborious and time-consuming for a corporation to efficiently monitor particular trademarks in such a huge trademark database.

What is needed, therefore, is a system and method which can monitor information of trademarks via a trademark information Web site automatically, for the sake of reducing labor intensity and enhancing work efficiency.

### SUMMARY OF THE INVENTION

One preferred embodiment provides a system for monitoring information of trademarks via a trademark information Web site. The trademark information Web site is accessible via the Internet. The system includes at least one client computer, a downloading server and a database server. The at least one client computer includes a setting module. The downloading server includes a searching module, an obtaining module and a downloading module. The database server includes a storing module. The setting module is configured for setting search conditions provided by the trademark information Web site. The searching module is configured for periodically searching trademarks via the trademark information Web site according to the search conditions. The obtaining module is configured for obtaining a search result table in response to the searching module. The downloading module is configured for downloading detailed information of the trademarks in the search result table. The storing module is configured for storing the detailed information of the trademarks downloaded into the database server.

Another preferred embodiment provides a method for monitoring information of trademarks via a trademark information Web site. The trademark information Web site is accessible via the Internet. The method includes the steps of: (a) setting search conditions, and periodically searching trademarks via the trademark information Web site according to the search conditions; (b) obtaining a search result table in response to the searching; (c) downloading detailed information of the trademarks in the search result table; and (d) storing the detailed information of the trademarks downloaded into the database server.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration and an application environment of a system for monitoring information of trademarks in accordance with a preferred embodiment;

FIG. 2 is a schematic diagram of hardware infrastructure of one of the client computers of FIG. 1;

FIG. 3 is a schematic diagram showing main function modules of the download server, the database server, the application server, and the client computer;

FIG. 4 is an exemplary schematic illustration of a search result table.

FIG. 5 is a flow chart of a preferred method for monitoring information of trademarks by utilizing the system of FIG. 1; and

FIG. 6 is a flow chart of details of step S506 of FIG. 5.

### DETAILED DESCRIPTION OF THE INVENTION

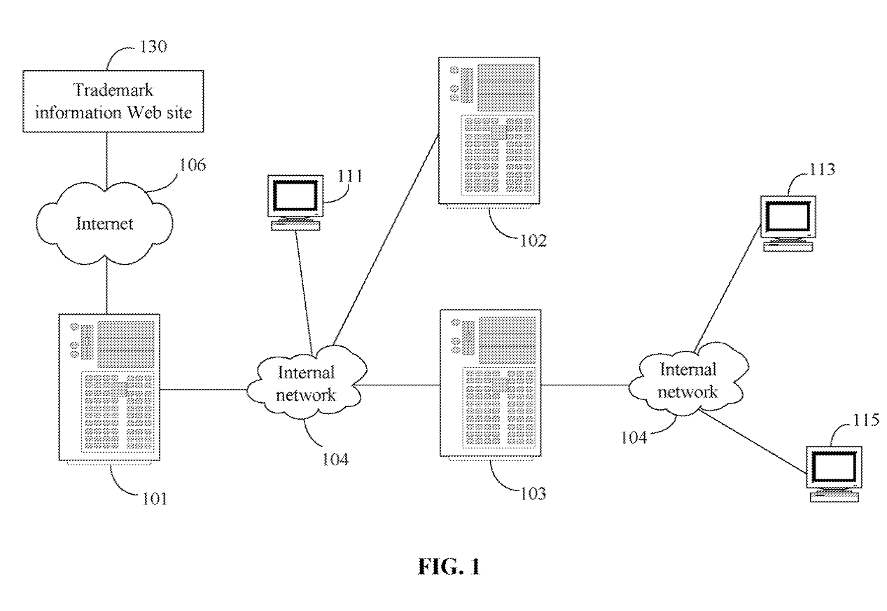

FIG. 1 is a schematic diagram of hardware configuration and an application environment of a system for monitoring information of trademarks (hereinafter “the system”) in accordance with a preferred embodiment. The system is typically configured in a three-layer framework. The three-layer framework includes a data access layer, a business logic layer, and a presentation layer. The data access layer includes a database server 102. The business logic layer includes a download server 101 and an application server 103. The presentation layer includes a plurality of client computers. For the purpose of conveniently illustrating the preferred embodiment of the present invention, three client computers 111, 113, 115 are shown and described hereinafter. An internal network 104 interconnects all the above-mentioned apparatuses.

The download server 101 connects with a plurality of trademark information Web sites 130 (only one shown) via the Internet 106, and is able to download trademark information from the trademark information Web sites 130. The trademark information Web sites 130 are Web sites of government trademark offices, such as the United States Patent and Trademark Office (USPTO), the Trademark Office under the State Administration for Industry and Commerce of People's Republic of China (CTMO), and so on.

The database server 102 stores all structured data of trademarks, and is configured for processing the stored data, such as read, write, delete, modify, update, and backup.

The application server 103 includes core and mutable enterprise logic (such as rules, execution, and management) of the system. The application server 103 is configured for processing input of users, and returning processing results to the users.

The client computers 111, 113, 115 have the function of receiving commands inputted by the users, and displaying results of implementation of such commands.

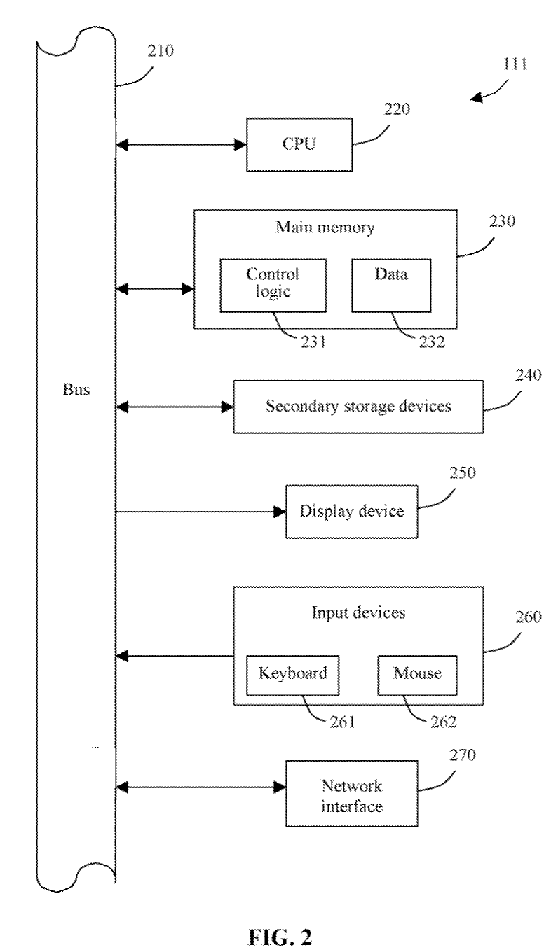

FIG. 2 is a schematic diagram of hardware infrastructure of the client computer 111. The client computers 113, 115, the download server 101, the database server 102 and the application server 103 each may include hardware infrastructure similar to that of the client computer 111. The client computer 111 may typically include the following units: a central processing unit (CPU) 220, a main memory 230, a plurality of secondary storage devices 240, a display device 250, a plurality of input devices 260, and one or more network interfaces 270. Each of the said units is connected with a common system bus 210, to communicate with one another.

The CPU 220 is the functional core of the client computer 111, and is configured for processing all computing tasks in the client computer 111. The bus 210 is configured for data exchange among the units in the client computer 111. The main memory 230 can be high-speed random access memory (RAM) and/or read only memory (ROM), and includes storage areas for control logic 231 and data 232. The main memory 230 may also include any additional or alternative high-speed memory device or memory circuitry. The secondary storage devices 240 are configured for storing all application programs and other data. The secondary storage devices 240 are preferably long term storage devices. Such devices may include ROM, optical or magnetic disks, organic memory, or any other suitable volatile or non-volatile mass storage system. The display device 250 displays prompting information for users. Such information assists users to input orders for processing data, and to view results of implementation of such orders. The input devices 260 receive control orders from users, and include a keyboard 261 and a mouse 262. Each network interface 270 controls communication between the client computer 111 and other computer devices.

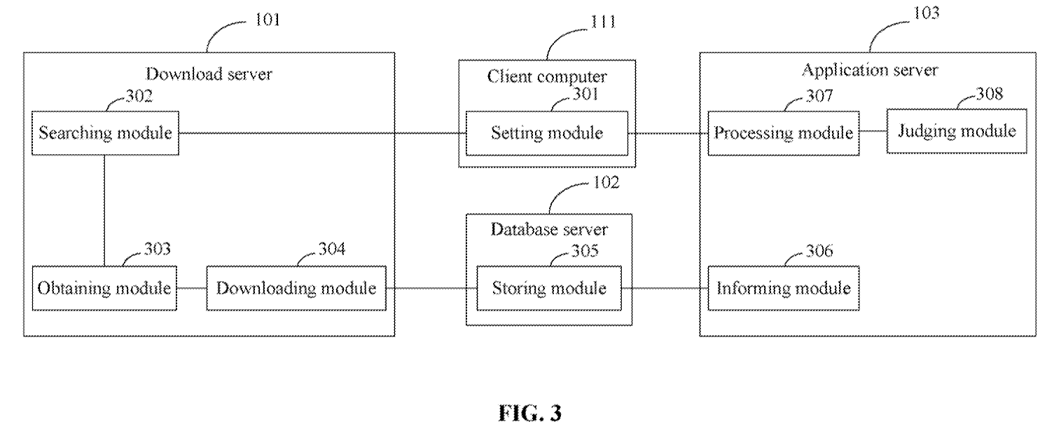

FIG. 3 is a schematic diagram of main function modules of the download server 101, the database server 102, the application server 103, and the client computer 111. The client computer 111 includes a setting module 301. The download server 101 includes a searching module 302, an obtaining module 303, and a downloading module 304. The database server 102 includes a storing module 305. The application server 103 includes an informing module 306, a processing module 307 and a judging module 308.

The setting module 301 is configured for setting search conditions. In detail, the setting module 301 can set search conditions provided by the trademark information Web sites 130. The search conditions refer to serial number, registration number, word mark, etc. The setting module 301 can also set query conditions of the database server 102.

The searching module 302 is configured for searching trademarks via the trademark information Web sites 130 periodically according to the search conditions, so that information of trademarks could be monitored. For instance, the CTMO publishes trademarks on 7^{th}, 14^{th}, 21^{st}, and 28^{th} every month. Correspondingly, the searching module 302 searches the trademark information Web sites 130 on 7^{th}, 14^{th}, 21^{st}, and 28^{th} every month.

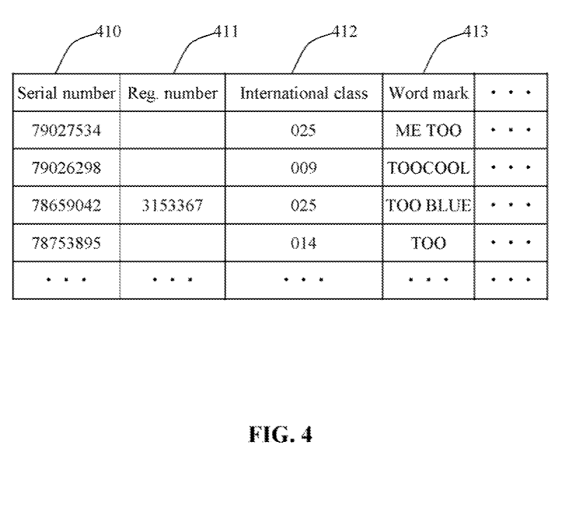

The obtaining module 303 is configured for obtaining a search result table in response to the searching module. The search result table (details will be described in FIG. 4) includes basic information of the trademarks that conforms to the search conditions.

The downloading module 304 is configured for downloading detailed information of the trademarks listed in the search result table. The detailed information of the trademarks here includes serial numbers, registration numbers, owner names, word marks, related web pages and so on.

The storing module 305 is configured for storing the detailed information of the trademarks downloaded into the database server 102.

The informing module 306 is configured for informing users of the downloaded trademarks via E-mails, and prompting the users whether to query information of trademarks in the database server 102.

The processing module 307 is configured for querying information of trademarks in the database server 102 according to the query conditions set by the setting module 301. The processing module 307 is also configured for getting query results.

The judging module 308 is configured for determining whether there is information of trademarks in the database server 102 matching the query conditions.

FIG. 4 is an exemplary schematic illustration of the search result table. The search result table mainly includes columns of serial number 410, registration number 411, international classification 412, and word mark 413. All data in the search result table have been mined from the trademark information Web sites 130.

The column for serial number 410 specifies serial numbers of trademarks. The column for registration number 411 specifies registration numbers of trademarks.

The column for international class 412 specifies classification codes of corresponding trademarks. The column for international class 412, ranged from 1 to 45 in Arabic numerals, is configured for classifying trademarks by field of application.

The column for word mark 413 specifies word marks of corresponding trademarks.

The search result table illustrated is exemplary of the preferred embodiment of the present invention. In alternative embodiments, the search result table may include one or more other columns in lieu of and/or in addition to the above-described columns 410, 411, 412, 413. Such other columns can provide other data on trademarks. Furthermore, the search result table may be replaced by two or more similar tables.

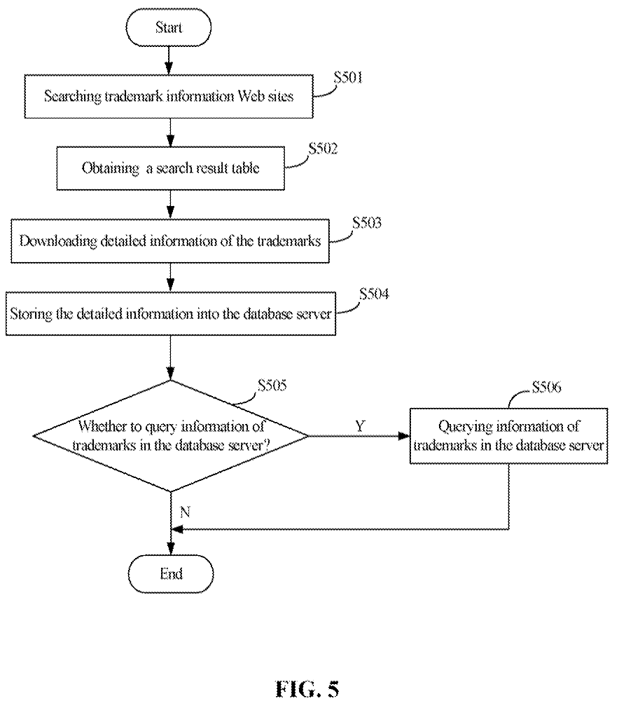

FIG. 5 is a flow chart illustrating a method for monitoring information of trademarks.

In step S501, the setting module 301 sets search conditions provided by the trademark information Web sites 130, such as a serial number, a registration number, a word mark, etc. The searching module 302 periodically searches the trademark information Web sites 130, so that information of trademarks could be monitored. Take the CTMO for example, the CTMO publishes trademarks on 7^{th}, 14^{th}, 21^{st}, and 28^{th} every month. Correspondingly, the searching module 302 searches the trademark information Web sites 130 on 7^{th}, 14^{th}, 21^{st}, and 28^{th} every month.

In step S502, the obtaining module 303 obtains a search result table according to the search performed by the searching module. The search result table includes basic information of the trademarks that conforms to the search conditions.

In step S503, the downloading module 304 downloads detailed information of the trademarks listed in the search result table. The detailed information of the trademarks includes serial numbers, registration numbers, owner names, word marks, related web pages and so on.

In step S504, the storing module 305 stores the detailed information of the trademarks downloaded into the database server 102. The informing module 306 informs users of the downloaded trademarks via E-mails. The E-mails are viewable in virtue of the display device 250, and related links are openable in the E-mails to view detailed information of downloaded trademarks.

In step S505, the informing module 306 prompts users whether to query information of trademarks in the database server 102. If users don't want to query information of trademarks in the database server 102, the procedure ends. Otherwise, if the users want to query information of trademarks in the database server 102, in step S506, the setting module 301 sets query conditions. The processing module 307 queries information of trademarks in the database server 102 according to the query conditions.

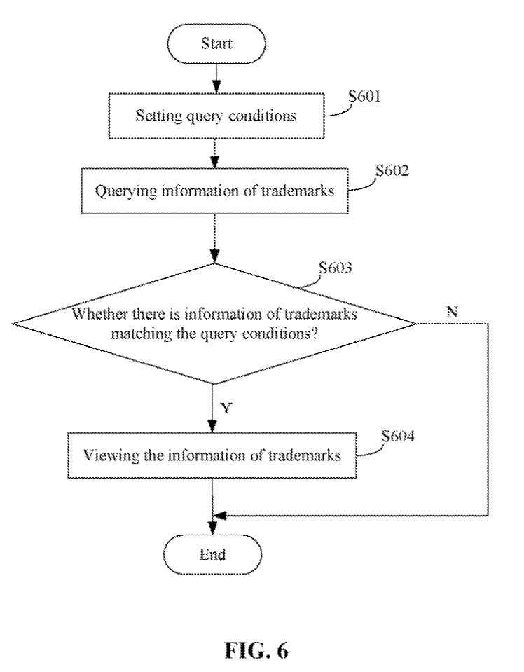

FIG. 6 is a flow chart of details of the step S506.

In step S601, the setting module 301 sets query conditions of the database server 102.

In step S602, the processing module 307 queries information of trademarks in the database server 102 according to the query conditions.

In step S603, the judging module 308 determines whether there is information of trademarks matching the query conditions. If no information of trademarks in the database server 102 can match the query conditions, the procedure ends. Otherwise, if any information of trademark in the database server 102 can match the query conditions, in step S604, the processing module 307 gets query results. The query results are viewable in virtue of the display device 205, and related links are openable to view details of the trademarks.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for monitoring information of trademarks via a trademark information Web site, the trademark information Web site being accessible via the Internet, the system comprising:
at least one client computer each comprising a setting module configured for setting search conditions provided by the trademark information Web site;
a downloading server comprising:
a searching module configured for periodically searching trademarks via the trademark information Web site according to the search conditions;
an obtaining module configured for obtaining a search result table in response to the searching module, the search result table listing basic information of trademarks retrieved from the trademark information Web site under the search conditions; and
a downloading module configured for downloading detailed information of the trademarks in the search result table; and
a database server comprising a storing module configured for storing the detailed information of the trademarks downloaded into the database server.

2. The system according to claim 1, wherein the search result table comprises columns of serial number, registration number, international classification, and word mark.

3. The system according to claim 1, wherein the detailed information of the trademarks comprises at least one item selected from the group consisting of serial numbers, registration numbers, owner names, word marks, and related web pages.

4. The system according to claim 1, further comprising an application server, the application server comprising an informing module configured for informing users of the downloaded trademarks, and prompting the users whether to query information of trademarks in the database server.

5. A method for monitoring information of trademarks via a trademark information Web site, the trademark information Web site being accessible via the Internet, the method comprising the steps of:
setting search conditions, and periodically searching trademarks via the trademark information Web site according to the search conditions;
obtaining a search result table in response to the searching, the search result table listing basic information of trademarks retrieved from the trademark information Web site under the search conditions;
downloading detailed information of the trademarks in the search result table; and
storing the detailed information of the trademarks downloaded into the database server.

6. The method according to claim 5, further comprising the steps of:
informing users of the downloaded trademarks; and
prompting the users whether to query information of trademarks in the database server.
